(19) United States
(12) Patent Application Publication
(10) Pub. No.: US 2004/0130971 A1
(43) Pub. Date: Jul. 8, 2004

(54) Screw-on crown for timepiece

(75) Inventors: Roger Ecoffet, Gex (FR); Sylvain Wenger, Fournex (CH)

Correspondence Address: SUGHRUE MION, PLLC, 2100 PENNSYLVANIA AVENUE, N.W., SUITE 800, WASHINGTON, DC, 20037, US

(73) Assignee: KS 22 S.A.

(21) Appl. No.: 10/671,792

(22) Filed: Sep. 29, 2003

(30) Foreign Application Priority Data
Oct. 17, 2002 (EP) 02079352.7

(51) Int. Cl. G04C 23/02; G04B 37/00

(52) U.S. Cl. 368/88

(57) ABSTRACT

The invention concerns a screw-on crown for a timepiece, including a head, a central portion and a lateral skirt, said head including an end face bearing a design, characterized in that the end face includes a substrate onto one face of which said design is applied, in that said substrate is mounted so as to move in rotation in said head and in that the crown further includes braking means arranged for holding said substrate in different angular orientations with respect to the head about the rotational axis of the crown.

The present invention concerns screw-on or screw crowns for timepieces and more particularly, crowns of this type including a design or logo on their end face and wherein said design can be oriented as desired.

Screw-on crowns are commonly fitted to watches for the purpose of improving the water resistance of the latter at their winding or control stem. This type of crown has the peculiarity of being able to take an unscrewed position in which the watch can be wound, set to the correct time etc. and a screwed in position in which the crown is screwed and locked onto a tube driven into the middle part of the watchcase in order to compress a sealing gasket, thus improving the water resistance of the watch. The screwed-in position is thus that which corresponds to the normal position when the watch is worn.

The manufacture and assembly of these screw-on crowns on watchcases are well known. However, the methods for assembling such crowns are ill suited to screw-on crowns bearing an inscription or a design, for example a logo, a trademark or similar. Indeed, the known manufacturing methods do not always allow the crown to be brought into a determined orientation with respect to the case after being unscrewed, which is detrimental to the aesthetic appearance of the case when an inscription is applied to the end face of the crown. This situation is, of course, unacceptable when such crowns are fitted to high quality, luxury products.

It is a main object of the present invention to overcome the drawbacks of the aforementioned prior art by providing a screw-on crown of simple and economical construction, including a pattern such as a logo or a trademark and wherein the position of the logo or the trademark applied onto the end face of said crown can easily be adjusted into a determined position or orientation after the crown has been screwed onto the tube.

The invention thus concerns a screw-on crown for a timepiece including a head, a central portion and a lateral skirt, the head including an end face bearing a design, the crown being characterized in that the end face includes a substrate on one face of which the design is applied, and in that the substrate is mounted so as to move in rotation in the head and in that the crown further includes braking means arranged to hold the substrate in different angular orientations with respect to the head about the rotational axis of the crown.

Owing to these features, the orientation of the design carried by the substrate can easily be adjusted into the desired position with respect to the middle part once the crown is in the screwed-in position, simply by rotating the substrate relatively to the head against the force of the braking means. The braking force generated by said braking means is of course adjusted such that the substrate cannot be rotated inadvertently when the watch is being worn, while allowing the latter to move to adjust its orientation.

According to an advantageous feature of the invention, the braking means act by friction on the substrate. The use of friction braking means allows continuous and fine adjustment of the orientation of the substrate and thus of the pattern with respect to the middle part of the watchcase.

Other features and advantages of the present invention will appear more clearly in the following description of a preferred embodiment, given by way of non-limiting example with reference to the annexed drawings, in which:

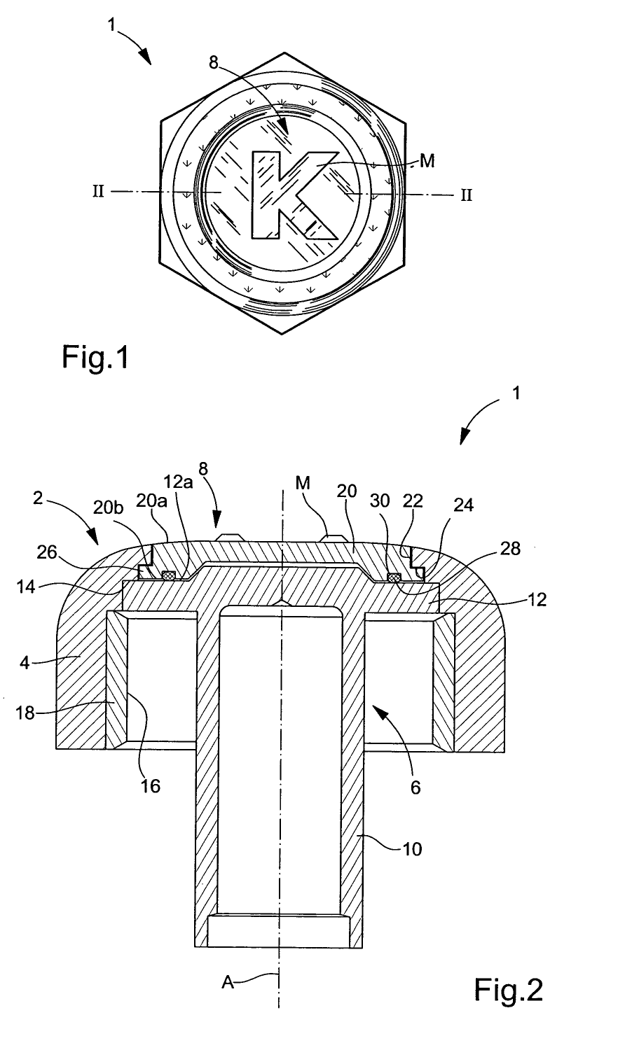

FIG. 1 shows a front view of a screw-on crown according to the invention, and

FIG. 2 shows a cross-section of the screw-on crown according to the invention along the line II-II of FIG. 1.

FIGS. 1 and 2 show a screw-on crown denoted by the general reference 1 and intended to be screwed onto a threaded tube (not shown) driven into the middle part of a watchcase (also not shown).

Crown 1 includes a first portion formed of a head 2 extended by a lateral skirt 4 surrounding a central portion 6 secured to the head. Head 2 includes an end or front face 8 on which a design such as a logo or trademark M is applied by stamping or engraving or by any suitable manner. Central portion 6 is intended to be connected to the clockwork movement in a conventional manner, via a winding or time-setting stem. In the example illustrated, central portion 6 is added and secured to head 2. Central portion 6 includes a tube 10 fitted with a disc 12 at one of its ends. Typically, central portion 6 is secured, for example by welding, bonding, crimping or any other appropriate means in a first shoulder 14 arranged in head 2. Lateral skirt 4 is provided, in its inner portion, with an internal screw thread 16 intended to cooperate with the thread of the tube driven into the middle part. In the example illustrated, internal screw thread 16 is added on by means of a threaded ring 18 secured to the inner wall of skirt 4. Here again, any appropriate means can be envisaged for such securing, by way of example, welding, bonding, crimping, etc. can be cited.

According to the invention, end face 8 includes a support member or substrate 20 including a front face 20a onto which design M is applied, and a rear face 20b. Substrate 20 is mounted so as to move in rotation in head 2 about rotational axis A of crown 1 such that front face 20a is visible from outside the crown. It can be seen in FIG. 2 that head 2 includes an aperture 22 having three stepped diameters respectively defining first shoulder 14 and a second shoulder 24 against which an annular edge 26 of substrate 20 rests. Moreover, braking means 28 are provided, which act via friction and which are arranged to hold substrate 20 in different angular orientations with respect to the middle part. Thus, when crown 1 is screwed as far as possible onto the tube driven into the middle part, design M can easily be moved angularly into a desired position against the friction force generated by braking means 28 and held in the desired position. Substrate 20 is thus gripped axially between front surface 12a of disc 12 and rear surface 20b of substrate 20. Preferably, the relative dimensions of the substrate, especially its thickness, and those of the head are selected such that front face 20a is flush with the front surface of crown 1 to form, therefore, a continuous surface.

According to a preferred embodiment, braking means 28 include an elastic annular element, which has elasticity especially in a direction parallel to rotational axis A. Typically, the annular element can be formed by a joint made of natural or synthetic compressible material. Annular element 28 is arranged between disc 12 and rear face 20b of the substrate in an annular groove 30, which can be arranged, either in rear face 20b of the substrate (FIG. 2), or in front face 12a of disc 12.

It will be noted that the desired braking force can be controlled by adapting the rate of compression of the annular element during manufacture.

It will also be noted that the use of a substrate added onto the crown allows the crown manufacturer to have a stock of heads/lateral skirts and central portions and to use these elements with substrates bearing different designs or other elements such as precious stones or suchlike. This type of crown also allows different materials to be easily combined to make the various elements that form it.

It will be understood that various modifications and/or improvements that are obvious to those skilled in the art could be made to the embodiment described in the present description without departing from the scope of the present invention defined by the annexed claims. In particular, one could use an undulated spring ring instead of annular joint 28 provided that it has compressible elasticity along axis A. One could also envisage arranging the braking means between the edge of substrate 20 and head 2. In yet another variant, one could envisage associating indexing notches with the braking means in order to position the substrate in a plurality of predefined angular positions. Finally, although substrate 20 is made in the shape of a plate or disc in the illustrated example, it goes without saying that other shapes of substrate 20 could be envisaged, provided that the substrate can be rotated relative to the portion of the crown screwed onto the tube driven into the middle part, against the braking means.

What is claimed is:

1. A crown for a timepiece, including a head, a central portion and a lateral skirt, said head including an end face bearing a design, wherein the end face includes a substrate onto one face of which said design is applied, wherein said substrate is mounted so as to move in rotation in said head and wherein the crown further includes braking means arranged for holding said substrate in different angular orientations with respect to the head about the rotational axis of the crown.

2. A crown according to claim 1, wherein said braking means act via friction.

3. A crown according to claim 2, wherein said braking means comprises an elastic annular element.

4. A crown according to claim 3, wherein said annular element is elastic in a direction parallel to the rotational axis of the crown.

5. A crown according to claim 1, wherein said braking means are formed by an annular joint made of a compressible material.

6. A crown according to claim 1, wherein the central portion is added onto the head, wherein said central portion includes a tube fitted with a disc at one of its ends, wherein said substrate includes an annular edge and wherein said substrate is gripped axially via its edge between the disc and the head.

7. A crown according to claim 6, wherein said braking means are arranged between the disc and the substrate.

8. A crown according to claim 1 of the screw-on type.
